(19) United States
(12) Patent Application Publication
(10) Pub. No.: US 2018/0178489 A1
(43) Pub. Date: Jun. 28, 2018

(54) COMPOSITE COMPONENT

(71) Applicant: ROLLS-ROYCE plc, London (GB)

(72) Inventors: Beene M'Membe, Bristol (GB); Alexander Lycett, Birmingham (GB); Mehdi Yasaee, Bristol (GB); Stephen Hallett, Bristol (GB); Ivana Partridge, Bristol (GB)

(73) Assignee: ROLLS-ROYCE plc, London (GB)

(21) Appl. No.: 15/838,676

(22) Filed: Dec. 12, 2017

(30) Foreign Application Priority Data
Dec. 20, 2016 (GB) 1621706.9

(51) Int. Cl. B32B 7/08; B29C 65/56; B29C 65/00; B29C 70/24; F01D 5/28

(52) U.S. Cl. CPC B32B 7/08; F05D 2300/611; B29C 66/721; B29C 70/24; F01D 5/282; B32B 2305/08; B32B 2603/00; B32B 2262/12; B32B 2262/103; B32B 2262/106; F05D 2300/505; F05D 2300/174; F05D 2300/224; F05D 2300/6034; B29C 65/564

(57) ABSTRACT

A composite component comprises a plurality of plies; and a plurality of pins extending through the plies in a direction transverse to the plies. Each of the pins comprises a shape memory alloy.

### CROSS-REFERENCE TO RELATED APPLICATION

This application is based upon and claims the benefit of priority from British Patent Application Number 1621706.9 filed 20 Dec. 2016, the entire contents of which are incorporated by reference.

### BACKGROUND OF THE INVENTION

The present disclosure concerns a composite component, a fan blade, a casing and/or a gas turbine engine.

Gas turbine engines are typically employed to power aircraft. Typically a gas turbine engine will comprise an axial fan driven by an engine core. The engine core is generally made up of one or more turbines which drive respective compressors via coaxial shafts. The fan is usually driven off an additional lower pressure turbine in the engine core.

The fan comprises an array of radially extending fan blades mounted on a rotor. The fan blades and/or a casing that surrounds the fan may be manufactured from metallic and/or composite (e.g. non-metallic) materials. In composite fan blades, the blades may include a composite body and a metallic leading edge and a metallic trailing edge.

Composite components are often laminate structures that include a plurality of plies. Each ply generally includes reinforcing fibres (e.g. high strength or high stiffness fibres) embedded in a matrix, e.g. a plastic matrix material. The matrix material of adjacent stacked plies is bonded together to build the composite component. The matrix material is weaker than the fibre material and as such the bond between stacked plies can form a point of weakness. This means that a primary failure mechanism of concern for composite materials is delamination.

Delamination for example of a fan blade may occur in the event of an impact by a foreign object such as a bird strike. To reduce the risk of delamination of a composite component through thickness reinforcement can be used. One type of through thickness reinforcement is pinning (which may be referred to as z-pinning). A component that has been pinned includes a plurality of pins (or rods) extending through the thickness of the component in a direction transverse to the general direction of the plies. Pins are generally made of a composite material (e.g. carbon embedded in a resin matrix) and typically have a diameter ranging from or equal to approximately 0.2 mm to 1 mm.

Often, composite pins are manufactured by pultrusion of a carbon fibre tow impregnated by a thermoset resin. The pins of a composite component exert a bridging force on the plies to hold the plies in position relative to each other, this reduces opening of inter-laminar cracks (known as mode I failure) and sliding displacements of inter-laminar cracks (known as mode II failure).

When a fan blade is impacted, e.g. by a bird strike, the fan blade will experience mode I and mode II loading. As such, the pins need to be able to resist delamination in both mode I and mode II.

### BRIEF SUMMARY OF THE DISCLOSURE

According to an aspect of the disclosure there is provided a composite component comprising a plurality of plies and a plurality of pins extending through the plies in a direction transverse to the plies. Each of the pins comprise a shape memory alloy.

The plies may comprise fibres suspended in a matrix material. For example, the plies may be made from carbon fibres suspended in a plastic matrix.

The shape memory alloy may comprise approximately 40 to 60% by weight nickel, and approximately 60 to 40% by weight of titanium. Such an alloy is commonly referred to as nitinol.

The pin may have a solid body, e.g. a solid cylindrical body.

Each of the pins may comprise a plurality of filaments of shape memory alloy interlaced together.

The filaments may be entwined along their length. Each pin may comprise only two filaments. The filaments may be initially provided in a straight configuration and then twisted around one another to form respective interlocked helices. Alternatively, the filaments may be plaited together along their length.

Each of the pins may comprise a core comprising the shape memory alloy, and a carbon reinforced composite material may surround the shape memory alloy.

Each of the pins may be coated with an abrasive coating. The abrasive coating may comprise diamond, for example a plurality of diamond particles. The diamond particles may have an average particle size in the range of 5 to 100 micron, and optionally in the range of 30 to 50 microns, e.g. a particle size of approximately 40 microns.

The composite may comprise a further plurality of pins made from a reinforced matrix material, for example the pins may be composite fibre reinforced pins.

The component may be a fan blade. Alternatively, the component may be a composite casing, e.g. a fan casing, composite stringer, or a composite joint.

In an aspect there is provided a gas turbine engine comprising the composite component according to the previous aspect.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 is a perspective view of a fan blade;

FIG. 3 is a cross sectional schematic view of a laminate that is reinforced with pins and may define part of the blade of FIG. 2;

FIG. 4 is a graph comparing the energy absorption of a shape memory alloy pin compared to a steel pin at different mixed mode failures;

FIGS. 5A and 5B are photos of pins after loading at a 30 degree mixed mode angle, FIG. 5A illustrates a shape memory alloy pin and FIG. 5B illustrates a stainless steel pin;

FIGS. 6A and 6B are photos of pins after loading at a 90 degree mixed mode angle, FIG. 6A illustrates a shape memory alloy pin and FIG. 6B illustrates a stainless steel pin;

FIGS. 7 to 10 are schematic illustrations of different types of pins; and

FIG. 11 is a cross sectional schematic view of a laminate having two different types of pins.

### DETAILED DESCRIPTION OF THE DRAWINGS

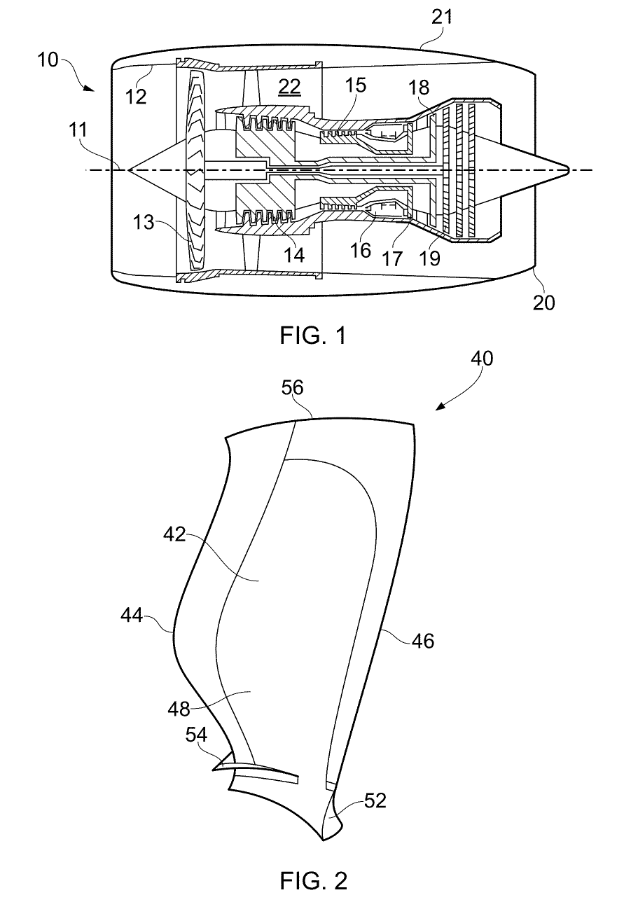

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

The intake fan 12 comprises an array of radially extending fan blades 40 that are mounted to the shaft 26. The shaft 26 may be considered a hub at the position where the fan blades 40 are mounted. The fan blades are surrounded by a fan casing 39, which may be made from a composite material.

Referring to FIG. 2, the fan blades 40 each comprise an aerofoil portion 42 having a leading edge 44, a trailing edge 46, a concave pressure surface wall 48 extending from the leading edge to the trailing edge and a convex suction surface wall extending from the leading edge to the trailing edge. The fan blade has a root 52 via which the blade can be connected to the hub. The fan blade has a tip 56 at an opposing end to the root. The fan blade may also have an integral platform 54 which may be hollow or ribbed for out of plane bending stiffness. The fan blade includes a metallic leading edge and a metallic trailing edge. The remainder of the blade (e.g. the body of the blade) is made from composite material.

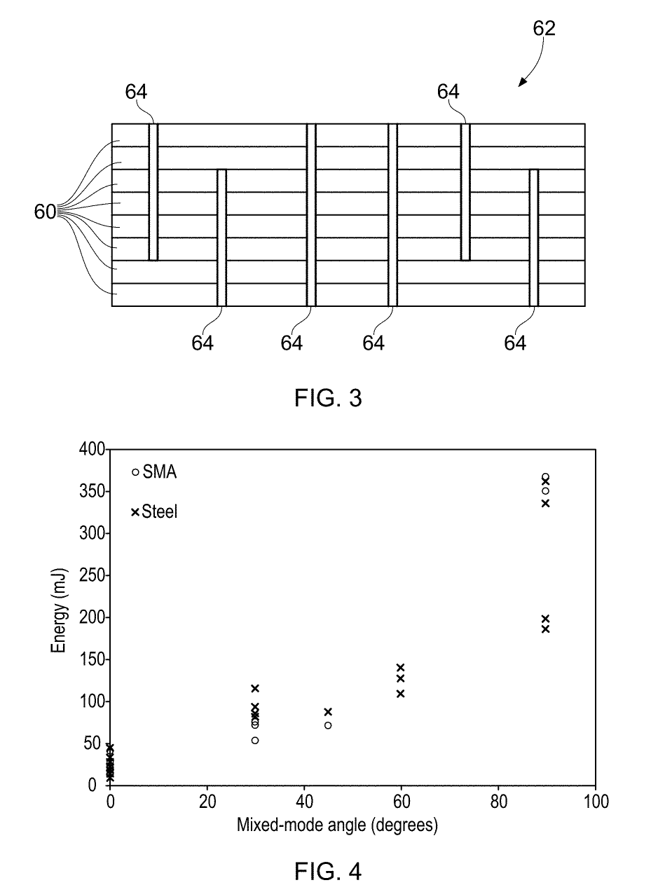

Referring to FIG. 3, the composite material includes a laminate 60 having a plurality of plies 62 reinforced by pins 64. The pins 64 extend through the thickness of the laminate and are transverse to the plies. In the present example the pins are arranged substantially perpendicular to the plies, but in alternative embodiments the pins may be angled by a different angle, e.g. 45° to the plies. The pins may be arranged to extend through the full thickness of a component or through the partial thickness of a component, and/or a component may have pins extending from one surface of the component or from opposing surfaces of the component.

The pins 64 may be inserted into the laminate 62 of the composite component using an ultrasonic hammer or using the method described in U.S. Pat. No. 8,893,367 which is incorporated herein by reference. In both examples, the pins are inserted before the laminate is fully cured.

The pins 64 are made from a shape memory alloy, for example nitinol, e.g. Nitinol 55 or Nitinol 60. Nitinol is an alloy of nickel and titanium and comprises a similar amount by weight of nickel to titanium, for example in a ratio of 40:60 up to 60:40 of nickel to titanium.

To test the performance of pins made from nitinol, the energy absorption of nitinol pins and stainless steel pins was tested. A pin to be tested was inserted into a quasi-isotropic laminate made from prepreg tape, and was tested at a range of mixed mode angles. The laminate was 20×20 mm and had a thickness of 8 mm. A layer of PTFE was inserted at the mid-plane of the laminate to simulate a crack. The nitinol pin had a diameter of 400 μm and the stainless steel pin had a diameter of 300 μm. The pins were then tested.

Referring to FIG. 4, the energy absorption of the nitinol pins is comparable to that of the stainless steel pins across the spectrum of mixed mode I and II.

However, the advantage of shape memory alloy pins, such as nitinol pins, over stainless steel and other metallic pins is the ability to resist large plastic deformations.

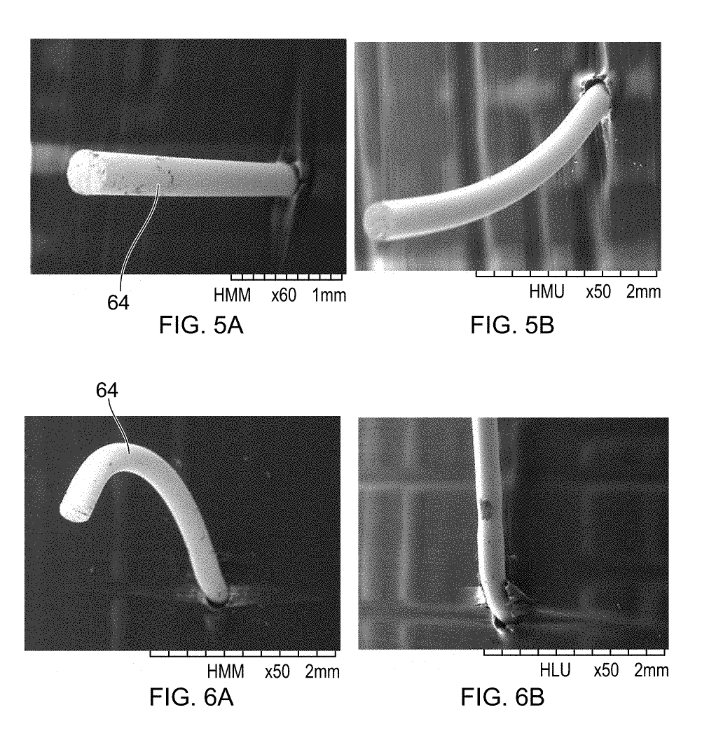

Referring to FIGS. 5A and 5B, at a mixed mode of 30 degrees, the nitinol pin (FIG. 5A) does not show any signs of deformation, whereas the stainless steel pin (FIG. 5B) is permanently deformed. At 90 degree mixed mode (i.e. mode II failure) the nitinol pins (FIG. 6A) are deformed but they are not deformed to the same extent as the stainless steel pins (FIG. 6B) which are bent through an angle of 90 degreees.

As such, nitinol pins can improve suppression of delamination, particularly in mode II failure. To improve the performance of the pins in mode I failure, the pin structure can be modified from a straight pin, the outer surface of the pin can be modified, or a mixture of nitinol and carbon pins may be used.

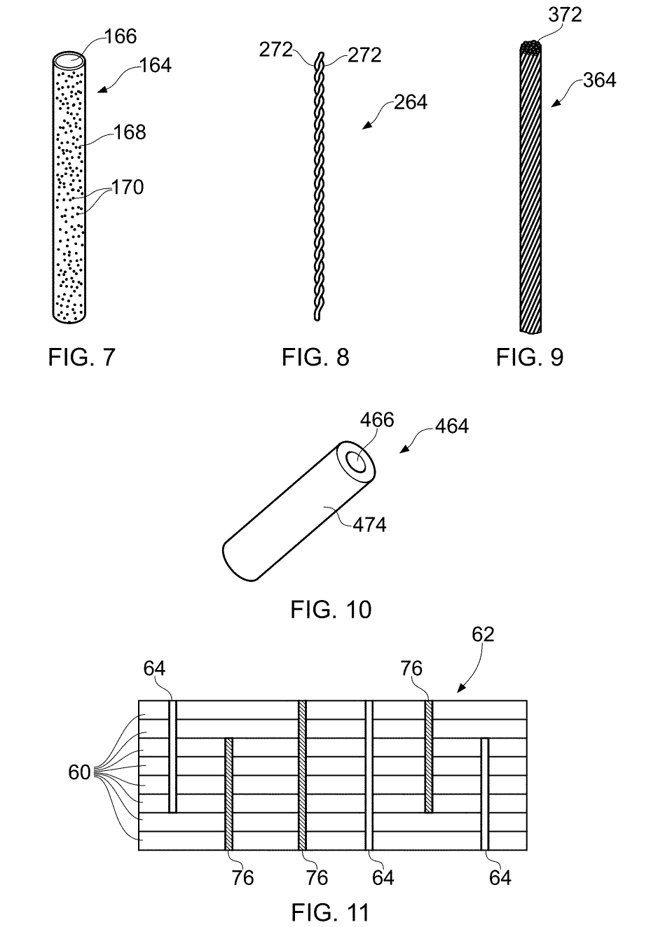

Referring to FIGS. 7 to 10, a number of different pins are illustrated. FIG. 7 illustrates a pin 164 with a core 166 made from a shape memory alloy and a coating 168 surrounding the core. The coating is an abrasive coating and includes diamond particles 170. The coating may be similar to that described in US2015/0165722 and incorporated herein by reference.

FIG. 8 illustrates a pin 264 which is formed from two filaments 272 that are intertwined together, for example twisted together as shown in FIG. 8. The pin 264 may have a structure similar to the pin described in US2015/0165721 and incorporated herein by reference. In FIG. 8 two filaments are illustrated, but in alternative examples more filaments may be provided, as illustrated in pin 364 of FIG. 9 which has filaments 372.

FIG. 10 illustrates a further alternative pin 464 which includes a core 466 made from a shape memory alloy and has an outer region 474 that surrounds the core 466. This pin may have a similar structure to the pin described in application U.S. Ser. No. 15/222011 and incorporated herein by reference.

Referring to FIG. 11, one of the pins shown in FIGS. 7 to 10, or another type of shape memory alloy pin 64 may be used in combination with a plurality of pins made from a different material. For example, the different material may be a carbon composite pin, e.g. a carbon fibre reinforced resin, similar to conventional pins used to reinforce a composite component. For example, the arrangement of the pins may be similar to that described in application GB1603951.3 which is incorporated herein by reference.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A composite component comprising:
a plurality of plies; and
a plurality of pins extending through the plies in a direction transverse to the plies;
wherein each of the pins comprises a core comprising the shape memory alloy and a carbon reinforced composite material surrounding the core.

2. The composite component according to claim 1, wherein the shape memory alloy comprises approximately 40 to 60% by weight nickel, and approximately 60 to 40% by weight of titanium.

3. The composite component according to claim 1, wherein each of the pins are coated with an abrasive coating.

4. A composite component comprising:
a plurality of plies;
a first plurality of pins extending through the plies in a direction transverse to the plies, the first plurality of pins being made from a reinforced matrix material; and
a second plurality of pins extending through the plies in a direction transverse to the plies, the second plurality of pins being made from a shape memory alloy.

5. The composite component according to claim 4, wherein the first plurality of pins are made form a carbon reinforced matrix material.

6. The composite component according to claim 4, wherein the shape memory alloy comprises approximately 40 to 60% by weight nickel, and approximately 60 to 40% by weight of titanium.

7. The composite component according to claim 4, wherein each of the pins of the second plurality of pins are coated with an abrasive coating.

8. The composite component according to claim 4, wherein the component is a fan blade.

9. A gas turbine engine comprising the composite component according to claim 4.

10. The composite component according to claim 1, wherein the component is a fan blade.

11. A gas turbine engine comprising the composite component according to claim 1.
